(19) United States
(12) Patent Application Publication
(10) Pub. No.: US 2015/0030529 A1
(43) Pub. Date: Jan. 29, 2015

(54) ISOTHERMAL SYNTHESIS OF FUELS WITH REACTIVE OXIDES

(71) Applicants: Yong Hao, Pasadena, CA (US); William C. Chueh, Menlo Park, CA (US); Sossina M. Haile, Pasadena, CA (US)

(72) Inventors: Yong Hao, Pasadena, CA (US); William C. Chueh, Menlo Park, CA (US); Sossina M. Haile, Pasadena, CA (US)

(73) Assignee: California Institute of Technology, Pasadena, CA (US)

(21) Appl. No.: 14/128,573

(22) PCT Filed: Jun. 25, 2012
(86) PCT No.: PCT/US12/43991

§ 371 Date: Jul. 7, 2014

Related U.S. Application Data
(60) Provisional application No. 61/501,078, filed on Jun. 24, 2011.
(60) Provisional application No. 61/504,461, filed on Jul. 5, 2011.
(60) Provisional application No. 61/511,428, filed on Jul. 25, 2011.

(51) Int. Cl. C01B 3/06; C01D 1/02; C01D 17/00; C01G 25/02

(52) U.S. Cl. CPC C01B 3/063; C01G 25/02; C01D 1/02; C01D 17/003
USPC 423/657; 264/628

(57) ABSTRACT

A method for converting thermal energy to chemical energy by reducing a reactive oxide substrate at a constant temperature under a first atmosphere with a lower oxygen partial pressure, and then contacting the reduced oxide at the same temperature with a second atmosphere with a higher oxygen partial pressure, during which oxygen is driven into the reduced oxide by the oxygen chemical potential difference between the two atmospheres, thereby leaving fuel behind, i.e. producing fuel. A method for preparing the reactive oxide substrate by using liquid media as a binder and pore former and heating the mixture of the reactive oxide and the liquid media, thereby forming the reactive oxide substrate.

### CROSS-REFERENCES TO RELATED APPLICATIONS

This application claims priority to U.S. Provisional Application Nos. 61/501,078, filed Jun. 24, 2011, 61/504,461, filed Jul. 5, 2011, and 61/511,428, filed Jul. 25, 2011, which are incorporated in their entirety herein for all purposes.

### STATEMENT AS TO RIGHTS TO INVENTIONS MADE UNDER FEDERALLY SPONSORED RESEARCH AND DEVELOPMENT

This invention was made with government support under CBET0929114 awarded by the National Science Foundation. The government has certain rights in the invention.

### BACKGROUND OF THE INVENTION

Previous studies have shown that selected reactive oxides can be used for synthesizing fuels in a two-temperature thermal cycle, where the thermal energy can come from, but is not limited to solar energy. In such a process, the reactive oxide is reduced at a first, higher temperature (TH), and then contacts a gas mixture at a second, lower temperature (TL), thereby producing fuel. While the process can be carried out using reactive oxides that undergo stoichiometric phase changes, e.g., between M₃O₄ and MO, more recent studies have shown that non-stoichiometric materials, which vary in oxidation state between MO_{2-dL} (at low temperature) to MO_{2-dH} (at high temperature), can also be used, and can produce fuel more quickly than stoichiometric phase change materials.

The two-temperature thermal cycle has many apparent disadvantages. First, thermal efficiency is low at both thermodynamic level and system levels. This is because both the oxide material and the reaction chamber must be heated to TH in the first half-cycle, and yet this energy has to be dumped to the environment to reach TL in the second half-cycle. Due to the large mass, the energy so wasted can be orders of magnitude higher than the energy converted into the fuel synthesized. Thermal energy recycling is not impossible, but can only be implemented at the cost of increasing the complexity of the system design. Second, severe thermal stress in both the reactive oxide substrate and the system components is incurred due to the rapid heating/cooling of such processes. This greatly reduces the lifetime and drives up the cost of the system. Third, the requirements on the same reactor being well-insulating during the TH cycle (for fast heating) and yet being well-conducting during the TL cycle (for fast cooling) are contradictory, which results in an elongated period in either (or perhaps both) half-cycles, lowering temporal productivity. Fourth, the reaction kinetics at TL can be extremely slow, further prolonging the cycle time and lowering the temporal productivity.

Beyond the challenges inherent to two-temperature thermal cycling, effective utilization of any reactive oxide in a thermochemical process requires that the oxide be formed such that it has high surface area and short distances for solid state diffusion. The ideal configuration is porous monolith. In general, creating porous monolithic ceramics is extremely time-consuming and costly. Surprisingly, the present invention meets this and other needs.

### BRIEF SUMMARY OF THE INVENTION

In some embodiments, the present invention provides a method of preparing a porous oxide, wherein the method includes forming a reaction mixture having an oxide powder and an alcohol, pressing the mixture, and sintering the pressed mixture at a temperature greater than about 1000° C., thereby preparing the porous oxide having a porosity of from about 50% to about 90%.

In some embodiments, the present invention provides a method for preparing a fuel including heating a reactive oxide substrate at a first temperature and a first partial pressure of oxygen, such that the reactive oxide substrate is reduced, and contacting the reduced reactive oxide substrate at the first temperature and a second partial pressure of oxygen, with a gas mixture having at least one of carbon dioxide and water, wherein the first partial pressure of oxygen is lower than the second partial pressure of oxygen, thereby preparing the fuel.

### BRIEF DESCRIPTION OF THE DRAWINGS

FIG. 1 shows a comparison of the two-temperature cycle and the isothermal cycle.

FIG. 2 shows the concentration of H₂ and O₂ due to thermolysis of water at different temperatures with the composition conditions given.

FIG. 3 shows fuel production from isothermal cycles with CeO_{2-δ} (2 wt % Rh) at 1500° C. and pH₂O=0.15 atm.

FIG. 4 shows SEM images of random porous structures prepared by (a) light pressing and the absence of fugitive pore-formers (Ce_{0.8}Zr_{0.2}O₂), and (b) heavy pressing with fugitive pore formers (CeO₂).

FIG. 5 shows oxygen release and hydrogen production of 10% Zr substituted ceria made by light pressing (solid lines) and heavy pressing (dashed lines) methods. Oxygen release at 1300° C. and pO₂=10⁻⁵ atm in Ar; Hydrogen production at 800° C. and pH₂O=0.15 atm in Ar. Materials have pore structures of the type shown in FIG. 4. Enhanced microstructure leads to faster hydrolysis rate. Times to reach 90% of completion of hydrogen production are 6 and 10 min, respectively.

### DETAILED DESCRIPTION OF THE INVENTION

### I. General

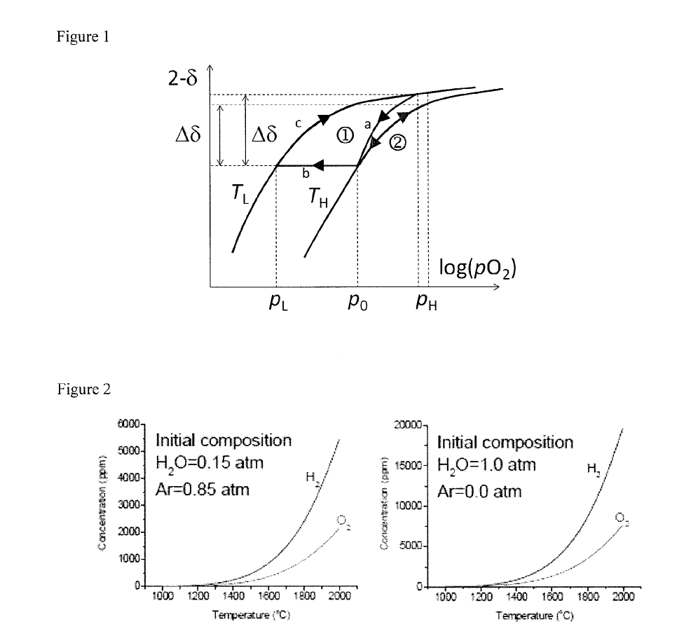

The present invention claims that nonstoichiometric oxides can operate in such a different mode that not only addresses the problems described above, but also greatly enhances fuel productivity, efficiency and system design. The difference between the present (isothermal) and past (two-temperature) methods is illustrated in FIG. 1. For a reactive oxide MO_{2-δ}, the past method is represented by cycle 1 in blue, during which the oxide is first heated under oxygen pressure p0 (typically 10⁻⁵ atm) from TL to TH (step a), and then rapidly cooled down to TL (step b), and then contacts with a gas mixture to synthesize fuel and gets simultaneously oxidized and restored to its original state for the next cycle (step c). The change of δ traversed by this process is noted by Δδ in blue.

The present invention, on the other hand, makes it possible for fuel synthesis to be achieved by fixing the temperature at TH and just alternating the gas atmosphere, shown by the red line and arrows in FIG. 1 (cycle 2). Instead of relying on the driving force of oxygen obtained by cooling the oxide down to an equivalent oxygen pressure pL, the present invention uses the higher oxygen pressure pH resulting from thermolysis of oxygen-containing compounds such as water. As is shown in FIG. 2, the oxygen pressure in thermally dissociated water increases exponentially with temperature. Starting from 1000° C., the oxygen partial pressure resulting from water thermolysis is higher than p0. Consequently, by exposing the reactive oxide to atmospheres with different oxygen partial pressures and allowing the oxide to reach equilibrium with the respective atmospheres, oxygen in the gas phase can be driven into or out of the oxide. The half cycle that drives oxygen into the oxide leaves fuel behind, i.e. produces fuel. The change of δ traversed by this process is noted by Δδ in red, and can be comparable to the change in δ traversed in the two-temperature cycle. Metaphorically, the reactive oxide works as an “oxygen sponge” during this isothermal cycle.

### II. Definitions

“Forming a reaction mixture” refers to the process of bringing into contact at least two distinct species such that they mix together and can react. It should be appreciated, however, the resulting reaction product can be produced directly from a reaction between the added reagents or from an intermediate from one or more of the added reagents which can be produced in the reaction mixture.

“Oxide powder” refers to a powder of an oxide of any metal. Exemplary oxide powders include, but are not limited to, cerium oxides. The oxide powder can be doped to form, for example, Ce_{0.8}Zr_{0.2}O_{2-δ}. One of skill in the art will appreciate that other metal oxides are useful in the present invention.

“Alkyl” refers to a straight or branched, saturated, aliphatic radical having the number of carbon atoms indicated. Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec.butyl, tent-butyl, pentyl, isopentyl, hexyl, etc. Alkyl can also refer to alkyl groups having up to 20 carbons atoms, such as, but not limited to heptyl, octyl, nonyl, decyl, etc. Alkyl groups can be substituted or unsubstituted.

“Alcohol” refers to an alkyl group, as defined within, having a hydroxy group attached to a carbon of the chain. For example, alcohol includes, but is not limited to, methanol, ethanol, propanol, isopropanol, butanol, isobutanol, tert-butanol, pentanol and hexanol, among others. Alcohols useful in the present invention are fully saturated. One of skill in the art will appreciate that other alcohols are useful in the present invention.

“Pressing” refers to the process of applying pressure to the mixture, such as via a cold-press or other type of press.

“Sintering” refers to the process of forming an object from a powder by heating the powder below the melting point such that the powder fuses together to form the object.

“Porosity” refers to the measure of void space in a material, and is represented by as a percentage of between 0 and 100%, with 0% having no void space and 100% being all void space.

“Fuel” includes gaseous or liquid substances that can themselves be burned, or combined with another substance and burned, to produce energy. Fuels useful in the present invention include, but are not limited to, molecular hydrogen (H₂), carbon monoxide, syngas (H₂ and CO), methane, and methanol.

“Reactive oxide substrate” includes a material capable of converting a gas mixture into a fuel. For example, the reactive oxide substrate can include a cerium oxide that is optionally doped. The reactive oxide substrate optionally includes a catalyst.

“Reduced reactive oxide substrate” includes the reactive oxide substrate that has been reduced to release molecular oxygen. For example, when the reactive oxide substrate is cerium oxide, CeO₂, the reduced form is CeO_{2-δ}, where δ is less than 0.5.

“Cerium oxide” includes CeO₂. In some embodiments, the cerium oxide can include a dopant to form a doped cerium oxide. Dopants useful in the doped cerium oxide include, but are not limited to transition metals such as Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. Other transition metals include the lanthanides (La, Ce, Pr, Nd, Pm, Sm, Eu, Gd, Tb, Dy, Ho, Er, Tm, Yb, and Lu) and actinides (Ac, Th, Pa, U, Np, Pu, Am, Cm, Bk, Cf, Es, Fm, Md, No, and Lr). In some other embodiments, the dopant can be a lanthanide. In still other embodiments, the dopant can be samarium, to provide samarium doped ceria (SDC). In yet other embodiments, the dopant can be gadolinium, to provide gadolinium doped ceria (GDC). In still yet other embodiments, the dopant can be yttrium or zirconium.

“Partial pressure” refers to the pressure a particular gas would have if it alone occupied the volume occupied by a mixture of gases.

“Contacting” refers to the process of bringing into contact at least two distinct species such that they can react. It should be appreciated, however, the resulting reaction product can be produced directly from a reaction between the added reagents or from an intermediate from one or more of the added reagents which can be produced in the reaction mixture.

“Gas mixture” includes the inlet gas that is converted to the fuel by the reactive oxide substrate. The gas mixture can contain a single gas, or several different gasses. The gas mixture can include gases such as water vapor, carbon dioxide, nitrous oxide, argon, nitrogen, hydrogen sulfide, and a combination thereof.

“Syngas” includes synthesis gas that contains molecular hydrogen and carbon monoxide in varying amounts. Syngas can also include other gasses, such as carbon dioxide.

### III. High Porosity Oxides

The present invention provides highly porous oxides. For example, the oxides can be cerium oxides or cerium zirconium oxides. In some embodiments, the present invention provides porous cerium zirconium oxides of formula I:

Ce₍₁₋ₓ₎ZrₓO_{2-δ}

wherein subscript x is from about 0 to about 0.5. Subscript x can be from about 0 to about 0.5, or from about 0.1 to about 0.5, or from about 0.1 to about 0.3, or from 0.1 to about 0.3. Subscript x can also be 0, or about 0.01, 0.05, 0.10, 0.15, 0.20, 0.25, 0.30, 0.35, 0.40, 0.45 or about 0.50. In some embodiments, subscript x can be 0.2

The oxides of the present invention can have any suitable porosity from about 1% to about 90%. In some embodiments, the oxides can have a porosity of from about 1% to about 90%, or from about 10% to about 90%, or from about 25% to about 90%, or from about 50% to about 90%, or from about 70% to about 90%, or from about 80% to about 90%. The oxides can also have a porosity of about 50, 60, 70, 75, 80, 85 or about 90%.

The oxides of the present invention can have pores of any size. In some embodiments, the pores are from about 10 nm to about 100 μm in diameter. In other embodiments, the pores are from about 200 nm to about 20 μm in diameter. Other pore sizes are also useful in the present invention.

The oxides of the present invention can have any suitable surface area. In some embodiments, the surface area of the oxide can be greater than 1 m² g⁻¹. In other embodiments, the surface area of the oxide can be greater than 10 m² g⁻¹. In still other embodiments, the surface area of the oxide can be greater than 25 m² g⁻¹. In yet other embodiments, the surface area of the oxide can about 32 m² g⁻¹.

The oxides of the present invention can have any suitable value for δ. For example, delta can be from 0 to about 0.5, or from 0.01 to about 0.3, or from about 0.1 to about 0.3.

The porous cerium zirconium oxides of formula I can be the product of a process described below for preparing porous oxides.

### IV. Method of Preparing Porous Oxides

The present invention provides a method of making a porous oxide. In some embodiments, the present invention provides a method of preparing a porous oxide, wherein the method includes forming a reaction mixture having an oxide powder and an alcohol, pressing the mixture, and sintering the pressed mixture at a temperature greater than about 1000° C., thereby preparing the porous oxide having a porosity of from about 50% to about 90%.

In some embodiments, the present invention provides a method of preparing a compound of formula I:

Ce₍₁₋ₓ₎ZrₓO_{2-δ}

wherein the method includes forming a reaction mixture having an oxide powder and an alcohol, pressing the mixture, and sintering the pressed mixture at a temperature greater than about 1000° C., wherein subscript x is from 0.01 to about 0.5, thereby preparing the compound of formula I having a porosity of from about 50% to about 90%.

Any suitable alcohol can be used in the method of the present invention. Without being bound to any particular theory, the alcohol used in the method of the present invention both binds the oxide powder so that the mixture can be pressed, and functions as a pore-former during sintering. In some embodiments, the alcohol can be methanol, ethanol, propanol or isopropanol. In some embodiments, the alcohol can be isopropanol. The alcohol can be used in any suitable amount in the method of the present invention.

The oxide powder can be any suitable reactive oxide. In some embodiments, the reactive oxide can be cerium oxide. In some embodiments, the reactive oxide can be cerium zirconium oxide of formula I. In other embodiments, the cerium zirconium oxide powder can be Ce_{0.8}Zr_{0.2}O_{2-δ}.

The oxide powder can be any suitable cerium zirconium oxide of formula I. In some embodiments, the cerium zirconium oxide powder can be Ce_{0.8}Zr_{0.2}O_{2-δ}.

The pressing can be accomplished using any suitable press at any suitable pressure. In some embodiments, the pressing is performed with a cold-press. Other pressing methods involve using a uniaxial die where the pressure is applied by hand-pressing.

The sintering can be performed at any suitable temperatures. For example, the temperature can be at least about 500° C., 600, 700, 800, 900, 1000, 1100, 1200, 1300, 1400 or at least about 1500° C. In some embodiments, the temperature can be about 1500° C.

The sintering can also be performed for any suitable length of time. For example, the sintering the can performed for a time of at least 10 minutes, 20, 30, 40, 50 or 60 minutes. The sintering can also be performed for at least 1 hour, or 2, 3, 4, 5, 6, 7, 8, 9 or 10 hours. In some embodiments, the sintering can be performed for a time of from about 10 minutes to about 10 hours. In some embodiments, the sintering can be performed for a time of about 2 hours.

The oxides of the present invention can have any suitable porosity from about 1% to about 90%. In some embodiments, the oxides can have a porosity of from about 1% to about 90%, or from about 10% to about 90%, or from about 25% to about 90%, or from about 50% to about 90%, or from about 70% to about 90%, or from about 80% to about 90%. The oxides of can also have a porosity of about 50, 60, 70, 75, 80, 85 or about 90%. In some embodiments, the compound of formula I can have a porosity of from about 70 to about 90%. In some embodiments, the compound of formula I can have a porosity of from about 80 to about 90%.

Subscript x of formula I can be from about 0.1 to about 0.5, or from about 0.1 to about 0.3, or from 0.1 to about 0.3. Subscript x can also be about 0.01, 0.05, 0.10, 0.15, 0.20, 0.25, 0.30, 0.35, 0.40, 0.45 or about 0.50. In some embodiments, subscript x can be 0.2.

In some embodiments, the method of the present invention includes forming a reaction mixture of an oxide powder of Ce_{0.8}Zr_{0.2}O_{2-δ} and isopropanol, pressing the mixture, and sintering the pressed mixture at a temperature of about 1500° C. for about 2 hour, thereby preparing the compound of formula I having a porosity of from about 80% to about 90%.

### V. Method of Preparing a Fuel

The present invention provides a method of preparing a fuel using an isothermal process. In some embodiments, the present invention provides a method for preparing a fuel including heating a reactive oxide substrate at a first temperature and a first partial pressure of oxygen, such that the reactive oxide substrate is reduced, and contacting the reduced reactive oxide substrate at the first temperature and a second partial pressure of oxygen, with a gas mixture having at least one of carbon dioxide and water, wherein the first partial pressure of oxygen is lower than the second partial pressure of oxygen, thereby preparing the fuel.

Any suitable reactive oxide substrate can be used in the method of the present invention. In some embodiments, the reactive oxide substrate includes cerium oxide, CeO₂.

In some embodiments, the reactive oxide substrate is the compound of formula I described above. In some embodiments, subscript x of formula I can be about 0.2.

The source of thermal energy for the heating step can be any suitable source capable of generating temperatures greater than 1000° C. Sources capable of generating the necessary thermal energy include, but are not limited to, solar energy, including solar concentration, power generation stations such as nuclear reactors, geothermal sources, etc.

The first temperature is any temperature suitable for forming the reduced form of the reactive oxide substrate. The first temperature can be greater than about 500° C., or 600, 700, 800, 900, 1000, 1100, 1200, 1300, 1400 or about 1500° C. In some embodiments, the first temperature is about 1000° C. In some embodiments, the first temperature is about 1500° C. In some embodiments, the first temperature is about 1300° C. Other temperatures for the first temperature are useful in the present invention.

Any suitable partial pressure of oxygen can be used in the method of the present invention. In some embodiments, the first partial pressure of oxygen can be from about 0.1 atm to about 10⁻⁸ atm. In some embodiments, the first partial pressure of oxygen can be about 10⁻⁶ atm. The second partial pressure of oxygen is greater than the first partial pressure of oxygen. In some embodiments, the second partial pressure of oxygen can be about 10⁻² atm.

The gas mixture can include any suitable components useful for the preparation of the fuel, as well as other inert or nonreactive gases. In some embodiments, the gas mixture can include at least one of carbon dioxide and water, or a combination thereof. In some embodiments, the gas mixture can include carbon dioxide. In some embodiments, the gas mixture can include water. In some embodiments, the gas mixture can include a combination of carbon dioxide and water. The method of the present invention is also tolerant to of other gases, such as nitrogen, hydrogen sulfide, and argon gasses.

When more than one gas is used in the gas mixture, any ratio of the different gasses can be used in the method. For example, when the gas mixture includes both water vapor and carbon dioxide, the ratio of partial pressure of water vapor (pH₂O) to partial pressure of carbon dioxide (pCO₂) can be from about 10:1 to about 1:10. In some embodiments, the ratio can be from about 10:1 to about 1:1. In other embodiments, the ratio can be from about 5:1 to about 1:1. In some other embodiments, the ratio can be from about 3:1 to about 1:1. In still other embodiments, the ratio can be about 2:1. Other ratios are useful in the method of the present invention.

The method of the present invention can include performing the heating and contacting steps a single time, or cycling through the heating and contacting steps several times. In some embodiments, the method also includes repeating the heating and contacting steps to prepare additional fuel.

The method of the present invention can prepare any fuel. In some embodiments, the fuel includes carbon monoxide. In other embodiments, the fuel includes a mixture of hydrogen and carbon monoxide (syngas). In some other embodiments, the fuel includes an alkane (such as C₁-C₈), such as methane, propane, butane, pentane, hexane, heptane, octane and combinations thereof. In still other embodiments, the fuel includes an alcohol, such as methanol, propanol, butanol, pentanol, hexanol, heptanol and combinations thereof. Other fuels are useful in the method of the present invention.

In some embodiments, the method of the present invention includes heating Ce_{0.8}Zr_{0.2}O_{2-δ} at about 1300° C. and a first partial pressure of oxygen of about 10⁻⁵ atm, such that the Ce_{0.8}Zr_{0.2}O_{2-δ} is reduced, and contacting the reduced Ce_{0.8}Zr_{0.2}O_{2-δ} at 1300° C. and a second partial pressure of oxygen of about 10⁻² atm, with a gas mixture comprising carbon dioxide or water, wherein the first partial pressure of oxygen is lower than the second partial pressure of oxygen, thereby preparing the fuel and oxidizing the reduced Ce_{0.8}Zr_{0.2}O_{2-δ} to form Ce_{0.8}Zr_{0.2}O_{2-δ}.

In some embodiments, the method of the present invention includes heating Ce_{0.8}Zr_{0.2}O_{2-δ} at about 1500° C. and a first partial pressure of oxygen of about 10⁻⁵ atm, such that the Ce_{0.8}Zr_{0.2}O_{2-δ} is reduced, and contacting the reduced Ce_{0.8}Zr_{0.2}O_{2-δ} at 1500° C. and a second partial pressure of oxygen of about 10⁻² atm, with a gas mixture comprising carbon dioxide or water, wherein the first partial pressure of oxygen is lower than the second partial pressure of oxygen, thereby preparing the fuel and oxidizing the reduced Ce_{0.8}Zr_{0.2}O_{2-δ} to form Ce_{0.8}Zr_{0.2}O_{2-δ}.

### VI. EXAMPLES

### Example 1

### Preparation of Porous Oxides (Ce_{0.7}Zr_{0.3}O_{2-δ}, Ce_{0.8}Zr_{0.2}O_{2-δ} and Ce_{0.9}Zr_{0.1}O_{2-δ}

An extremely simple and effective technique for obtaining high porosity (70-90%) structures has been developed. Oxide powders of the target compositions were first prepared by a chemical solution process using nitrate sources. This high surface area material was then lightly cold-pressed using isopropyl alcohol as a mild adhesive. Sintering was subsequently performed under stagnant air at 1500° C. for 2 hr. The typical resulting structure is shown in FIG. 4(b).

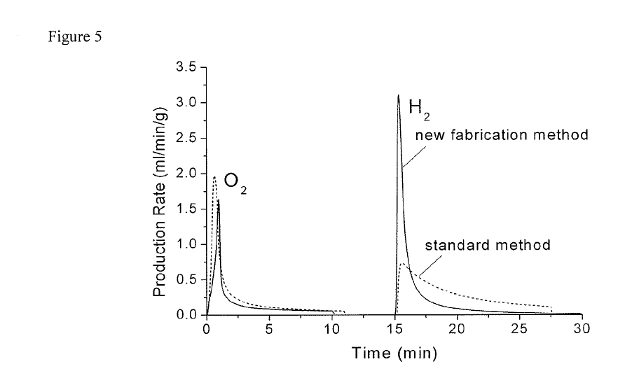

Comparative measurements of oxygen release and hydrogen production over 10% Zr substituted ceria are presented in FIG. 5 (as collected using the Caltech IR imaging furnace system). The porous oxide prepared by the new method displays substantially faster hydrogen production kinetics due to the improved microstructure (porosity and specific surface area).

### Example 2

### Preparation of Fuel

Fuel was produced using porous ceria-based materials, including CeO_{2-δ}, Ce₁₋ₓZrₓO_{2-δ} (0<x≦0.5) and Sm_{0.15}Ce_{0.85}O_{1.925-δ} (SDC15), prepared using the methods above.

Samples containing 1000 mg of the ceria-based material were loaded into a 10 mm diameter continuous flow packed bed reactor with the particles held in place by a porous quartz frit. Reaction gases were delivered by digital mass flow controllers, and the effluent gas was measured by a Varian CP-4900 gas chromatograph equipped with PoraPak Q and Molecular Sieve 5A columns. H₂, CH₄, CO and CO₂ concentrations were converted to flow rates using an internal N₂ standard, which also served as a diluent. In some cases, Ar was also used as a diluent. GC calibration curves were established using analytical grade premixed gases. The fuel was produced by flowing a mixture of H₂, H₂O, and Ar at 1500° C. with oxygen pressures being 10⁻⁵ atm for p0 and approximately 2. 10⁻⁴ atm for pH. Humidification was achieved by bubbling the reaction gas through a H₂O bubbler inside a temperature controlled bath.

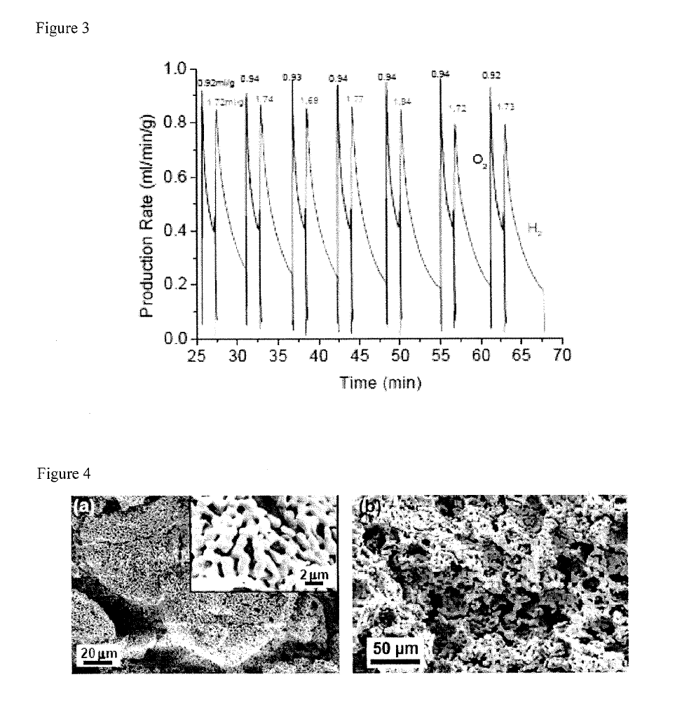

FIG. 3 shows the consecutive isothermal hydrolysis cycling with CeO_{2-δ} (2 wt % Rh) at 1500° C. with oxygen pressures being 10-5 atm for p0 and approximately 2×10⁻⁴ atm for pH in FIG. 2. Oxygen release occurs when the atmosphere is 10 ppm O₂ in Ar (2 min) and hydrogen production occurs when the atmosphere is switched to 15% water vapor in Ar (3.5 min). This particular sample contained 2 wt % Rh, but at this temperature the catalyst has negligible impact on the reaction rates. For one ton of ceria, the equivalent productivity of H₂ is 105 m³ (STP; standard conditions for temperature and pressure) per day, which is approximately 5 times of the productivity demonstrated in the art.

Fuel production rates for three different reactive oxides at two different temperatures are summarized and compared in Table 1. Overall, higher operational temperatures increases the fuel production rate. This reflects the greater degree of thermolysis that occurs as the vapor H₂O is heated to higher temperatures (the oxidizing potential of steam increases with temperature). It is noteworthy that the system efficiency in this case will depend strongly on the ability to recover the heat from the very high temperature fluid exhaust. That is, by moving to an isothermal cycle, the burden of heat recovery is shifted from the solid phase to the gas phase. Such a shift implies a tremendous decrease in the complexity of the heat recovery process.

TABLE 1
Fuel production rate (ml g⁻¹h⁻¹) upon isothermal cycling between
10 ppm O₂ in Ar and 15% water vapor in Ar at the temperatures
indicated.

| Sample Composition | 1500° C. | 1600° C. |
|---|---|---|
| 2 wt % Rh-ceria (undoped) | 17.5 | 22.5 |
| 2 wt % Rh—Zr_{0.3}Ce_{0.7}O_{2-δ} | 13.5 | 18.0 |
| SDC15 (Sm_{0.15}Ce_{0.85}O_{1.925-δ)} | 9.4 | 18.3 |

For undoped ceria, increasing the temperature to 1600° C. increases the H₂ productivity to 135 m³/ton/day (STP).

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A method of preparing a porous oxide, the method comprising:
forming a reaction mixture comprising an oxide powder and an alcohol;
pressing the mixture; and
sintering the pressed mixture at a temperature greater than about 1000° C., thereby preparing the porous oxide having a porosity of from about 50% to about 90%.

2. The method of claim 1, wherein the porous oxide is a compound of formula I:
Ce₍₁₋ₓ₎ZrₓO_{2-δ}
wherein subscript x is from 0 to about 0.5.

3. The method of claim 1, wherein the alcohol is selected from the group consisting of methanol, ethanol, propanol and isopropanol.

4. The method of claim 1, wherein the alcohol is isopropanol.

5. The method of claim 1, wherein the sintering is performed at a temperature of about 1500° C.

6. The method of claim 1, wherein the sintering is performed for a time of from about 10 minutes to about 10 hours.

7. The method of claim 1, wherein the sintering is performed for a time of about 2 hours.

8. The method of claim 1, wherein the compound has a porosity of from about 70 to about 90%.

9. The method of claim 1, wherein the compound has a porosity of from about 80 to about 90%.

10. The method of claim 1, wherein subscript x is about 0.2.

11. The method of claim 1, wherein the method comprises forming a reaction mixture comprising an oxide powder of Ce_{0.8}Zr_{0.2}O_{2-δ} and isopropanol;
pressing the mixture; and
sintering the pressed mixture at a temperature of about 1500° C. for about 2 hour, thereby preparing the porous oxide having a porosity of from about 80% to about 90%.

12. A method for preparing a fuel, the method comprising
heating a reactive oxide substrate at a first temperature and a first partial pressure of oxygen, such that the reactive oxide substrate is reduced; and
contacting the reduced reactive oxide substrate at the first temperature and a second partial pressure of oxygen, with a gas mixture comprising at least one of carbon dioxide and water, wherein the first partial pressure of oxygen is lower than the second partial pressure of oxygen, thereby preparing the fuel.

13. The method of claim 12, wherein the reactive oxide substrate comprises a compound of formula I:
Ce₍₁₋ₓ₎ZrₓO_{2-δ}
wherein subscript x is from about 0 to about 0.5.

14. The method of claim 13, wherein subscript x is about 0.2.

15. The method of claim 12, wherein the first temperature is greater than about 1000° C.

16. The method of claim 12, wherein the first temperature is about 1300° C.

17. The method of claim 12, wherein the first partial pressure of oxygen is from about 10⁻⁷ to about 10⁻³ atm.

18. The method of claim 12, wherein the first partial pressure of oxygen is about 10⁻⁵ atm.

19. The method of claim 12, wherein the second partial pressure of oxygen is about10⁻² atm.

20. The method of claim 12, wherein the gas mixture comprises at least one of carbon dioxide and water, or a combination thereof.

21. The method of claim 12, further comprising repeating the heating and contacting steps to prepare additional fuel.

22. The method of claim 12, comprising
heating Ce_{0.8}Zr_{0.2}O_{2-δ} at about 1500° C. and a first partial pressure of oxygen of about 10⁻⁵ atm, such that the Ce_{0.8}Zr_{0.2}O_{2-δ} is reduced; and
contacting the reduced Ce_{0.8}Zr_{0.2}O_{2-δ} at 1500° C. and a second partial pressure of oxygen of about 10⁻² atm, with a gas mixture comprising carbon dioxide or water, wherein the first partial pressure of oxygen is lower than the second partial pressure of oxygen, thereby preparing the fuel and oxidizing the reduced Ce_{0.8}Zr_{0.2}O_{2-δ} to form Ce_{0.8}Zr_{0.2}O_{2-δ}.
